(19) United States
(12) Patent Application Publication
(10) Pub. No.: US 2025/0000054 A1
(43) Pub. Date: Jan. 2, 2025

(54) Pet Travel Feeder on Wheels

(71) Applicant: Andrea C. Vaughan, Leesburg, VA (US)

(72) Inventor: Andrea C. Vaughan, Leesburg, VA (US)

(21) Appl. No.: 18/882,077

(22) Filed: Sep. 11, 2024

Related U.S. Application Data
(63) Continuation-in-part of application No. 18/412,764, filed on Jan. 15, 2024.
(60) Provisional application No. 63/576,811, filed on Mar. 8, 2023.

(51) Int. Cl. A01K 5/01; A45C 5/06; A45C 5/14; A45C 13/02; A45C 13/26; A45F 3/04

(52) U.S. Cl. CPC A01K 5/0107; A45C 5/065; A45C 5/14; A45C 13/02; A45C 13/26; A45F 3/04

(57) ABSTRACT

A method includes positioning a front cover at an initial position. The method also includes configuring a plurality of drawers to be placed within the front cover. The drawers are configured to carry food items for one or more periods. The one or more periods of time will include multiple week intervals. The method also includes placing a back cover behind the front cover and the plurality of drawers. The method also includes moving the combined front cover, plurality of drawers, and back over using one or more attachments. The one or more attachments are configured to lift and roll the combined front cover, plurality of drawers, and back cover.

### CROSS-REFERENCE TO RELATED APPLICATION

This application is a continuation-in-part application that claims priority to U.S. Non-Provisional application Ser. No. 18/412,764 filed on Jan. 15, 2024 and Provisional Application No. 63/576,811, filed Mar. 8, 2023, entitled, “Pet Travel Feeder On Wheels,” which is incorporated by reference in its entirety.

### TECHNICAL FIELD

The present inventive concept relates to a travelling apparatus to carry pet products from one location to another.

### BACKGROUND

A problem arises users attempt to travel with pet products including pet food and pet toys. There are issues when the user is travelling for one to two weeks at a time. The user will want to find a way to keep their pet products fresh while they are travelling. Problems can occur when the user is attempting to store their pet products in hopes that the pet products remains fresh.

The user may have difficulty determine what type of apparatus to use to store their pet products. A user may attempt to store the pet products in a traditional suitcase or backpack. However, such traditional luggage will often have other items that that will be interspersed with the pet products. The pet products can spill onto the other items, thereby compromising the freshness of the pet products. Another problem that can occur is that the traditional backpack and suitcase may not provide an air tight seal for the pet products. Outside air and other contamination can get into the backpack or suitcase and compromise the freshness of the pet products.

Another issue that users currently face is the need to take their pets with them. The users will often have to manually carry the pet or carry the pet within their kennel. Yet another issue is the need to carry extra pet products in the event that the currently stored pet products are exhausted. The users also are not able to find a device that they carry or roll while storing the pet products freshly.

A need exits for an apparatus or device that can enable users to store pet products freshly for several weeks at a time. A need also exists for a device or apparatus to enable the user to safely take their pet along with them during trips. Further, a need also exists for a device to enable the user to handle the weight of the pet products while taking the device or apparatus on the trip. Moreover, a need also exists for a device or apparatus that will allow the user to take water/fluids and additional pet supplies.

### SUMMARY

In accordance with the present invention, the present invention relates to a device that stores pet supplies and or food portioned out for multiple time intervals that can be lifted and rolled in multiple directions.

In an embodiment of the invention, a method includes positioning a front cover at an initial position. The method also includes configuring a plurality of drawers to be placed within the front cover. The plurality of drawers are configured to carry food items for one or more periods of time. The one or more periods of time will be up to multiple week intervals. The method also includes placing a back cover behind the front cover and the plurality of drawers. The method further includes moving the combined front cover, plurality of drawers, and back cover using one or more attachments. The one or more attachments are configured to lift and roll the combined front cover, plurality of drawers, and back cover.

The method also includes placing containers and covers within the back cover.

In an embodiment, a method includes configuring a plurality of drawers at an initial position. The method also includes placing one or more items within the drawers for storage. The one or more items are configured to be stored for intervals of time. The intervals of time include multiple week intervals. The method also includes positioning the drawers with the one or more items within a front cover of a traveling apparatus. The method also includes configuring an attachment apparatus on or above the front cover and drawers to move the front cover and drawers in one or more directions.

In an embodiment, the method includes where the attachment apparatus includes an arm to carry the drawers and front cover.

In an embodiment, a system includes a front cover configured at an initial position. The system also includes a plurality of drawers placed within the front cover. The plurality of drawers are configured to carry food items for one or more periods of time. The one or more periods of time will be multiple week intervals. The system also includes a back cover placed behind the front cover and the plurality of drawers. The system also includes one or more attachments that are placed on the combined front cover, plurality of drawers, and back cover. The one or more attachments are configured to lift and roll the combined front cover, plurality of drawers, and back cover.

The drawers also include labeled dates and hours to store the food items.

### BRIEF DESCRIPTION OF THE FIGURES

FIG. 1 illustrates a portion of an apparatus in accordance with an embodiment of the invention;

FIG. 2 illustrates another portion of the apparatus in an embodiment of the invention;

FIG. 3 illustrates another combined portion of the apparatus in an embodiment of the invention;

FIG. 4 illustrates the completed apparatus in accordance with another embodiment of the invention; and

FIG. 5 illustrates an additional attachment n accordance with an embodiment of the invention.

### DETAILED DESCRIPTION

Various embodiments will be described in detail in the specification and in the drawings. Reference numerals represent like parts and assemblies through several views. Reference to various embodiments do not limit the scope of the invention. Further, any additional examples set forth in this specification are not intended to be limiting and merely set forth some of the many possible embodiments for the claimed invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It will be further understood that the terms “comprises,” “comprising,” “includes,” and “including” specify the presence of stated features, steps or components, but do not preclude the presence or addition of one or more features, steps or components. It should also be noted that in some alternative implementations, the functions and acts may occur out of the order noted in the figures. Two figures shown in succession may be executed substantially concurrently or may sometimes be executed in the reverse order.

The term “invention” or “present invention” refers to the invention being applied may be used interchangeably with the travelling apparatus.

### INTRODUCTION

The present invention relates to a travelling apparatus that will enable a user with one or more pets to store pet products including pet food and pet toys and other pet items safely and efficiently. The travelling apparatus will function as a suitcase and as a backpack. The travelling apparatus will include a front cover and a back cover. The front cover will include drawers. Plastic storage container covers can be placed within the drawers that contain the pet products. In other embodiments, the user can also directly put the pet products within the drawers. The drawers and any plastic storage containers within the drawers will provide an air tight seal that will keep the pet products fresh for several weeks at a time.

The back cover will include plastic storage type containers and covers that will store the pet products within the back cover. As in the front cover, the pet products will be stored safely and securely and free from outside contamination within the plastic storage containers within the back cover of the travelling apparatus.

Another feature of the travelling apparatus is the handle or handle like mechanism at the top of the travelling apparatus. The handle will allow the user to roll the travelling apparatus in the same manner as a suitcase.

Yet another feature of the travelling apparatus will be backpack straps located on the back cover of the travelling apparatus. The backpack straps will allow the user to carry the travelling apparatus with the petfood as a backpack. The user can also carry the travelling apparatus with his/her hands as well using the backpack straps.

The user can also take his/her pet along with the travelling apparatus. The back portion of the travelling apparatus will include hooking connectors. The hooking connectors will allow the user to hook the travelling apparatus onto a stationary kennel that can store the pet for a period of time.

### Analysis

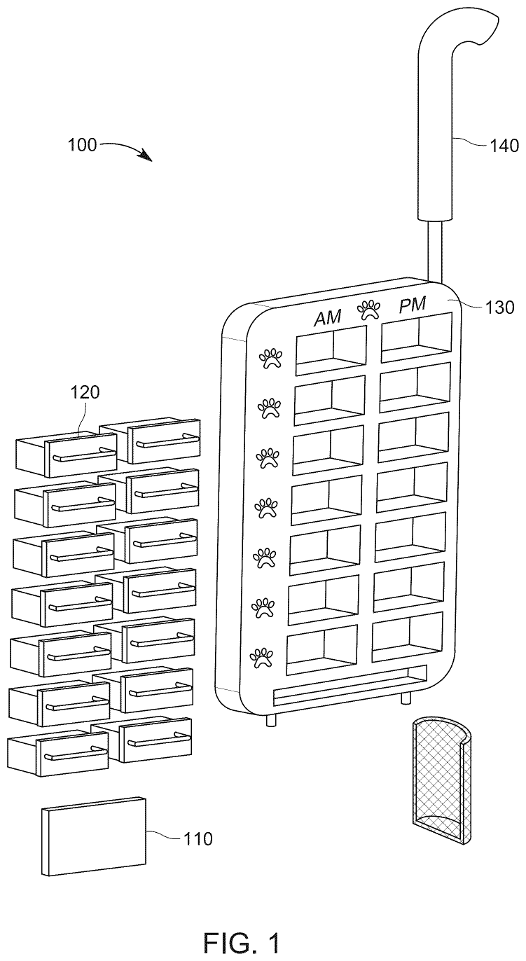

Referring to FIG. 1, a first portion of the travelling apparatus 100 is illustrated. The front cover 130 is also shown. The front cover will include drawers 120 that will be placed in various spaces within the front cover 130. The drawers 120 will be used to store various pet products to be carried within the travelling apparatus 100. The drawers 120 will include labeled dates and times to store the pet products. In other embodiments, plastic storage type containers with covers can also be used to store the pet products within the drawers 120. An information tag 110 will also be within the front cover 130. The information tag 110 will contain pieces of demographic information on the pet (emergency contact info, vet name, pet demographics, name of pet, general info of the pet, the medicine of the pet, etc.). A backpack strap 140 is also shown, which will be part also be part of the back cover. The backpack strap 140 will be used to enable the user to carry the travelling apparatus 100 on the user's shoulders. The backpack strap 140 will be on both sides of the front cover to enable the user to carry the travelling apparatus 100 on the user's shoulders or by hand.

Still referring to FIG. 1, the user will want to store various pet products for the user's pet or pets as the user is travelling from one location to another. The user travelling to the new location for multiple weeks by plane or train will want to store pet products within the drawers 120 that include labeled dates and times. The drawers 120 will be sealed air tight within the front cover 130, wherein a plastic storage container within the drawer can also be used to store the pet products, and provide the air tight seal to keep the pet products fresh. Each of the pockets of food in the respective drawers 120 will keep the stored food fresh from outside contamination. The user can use as many of the drawers 120 as needed to store the pet products within the front cover 130. As mentioned above, plastic storage type containers with covers can also be placed within the drawers 120 to provide an air tight seal for the pet products for several weeks at a time while the user is travelling. Moreover, the user will store the desired amount of pet products in one or more of the drawers 120 that will within the front cover 130. The front cover 130, with the drawers 120, and optionally with plastic storage containers, will ensure that the pet products are kept air tight and remains fresh for up to, but not limited to multiple week intervals.

Another aspect of FIG. 1 is shown by the backpack strap 140. The backpack strap 140 is an important attachment mechanism that provides versatility to the user. The backpack strap 140 will be present on both ends of the back cover. The user can effectively carry the travelling apparatus 100 in a similar banner to a backpack on the user's shoulders. The user can also hold the backpack straps 140 by hand as well. As such, the user can carry a large amount of pet products that are stored securely within the drawers 120 within the front cover 130. The backpack strap 140 on both ends at the back of the front cover 130 will enable the user to carry the pet products by hand or by the user's shoulders.

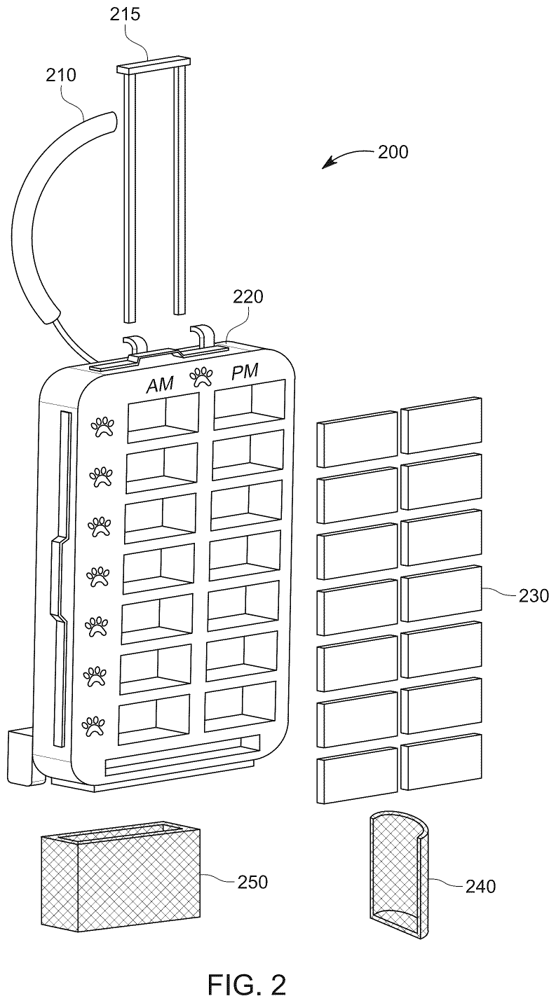

In FIG. 2, another aspect of the travelling apparatus 200 is shown. The back cover 220 is shown with features similar to the front cover shown in FIG. 1. The back cover 220 will include a backpack strap 210 and pulling handle 220. Both the backpack strap 210 and pulling handle 215 will enable the user to either carry or roll the travelling apparatus 200. Moreover, the back cover 220 will also include plastic storage container covers (covers) 230. The user will be able to store the pet products within the covers 230 and place the covers 230 within the back cover 220. In addition, the back cover 220 will also include hooking connectors 260. The hooking connectors 260 will be used to place the entire travelling apparatus 200 onto a stationary kennel when the user decides to place his/her pet in the stationary kennel. The back cover 220 will also include a pocket 250 to hold pet product items, and a bottle holder 240 as well.

Referring again to FIG. 2, the back cover 220 can be used to store pet products for the pet of the user for several weeks as the user is travelling by plane or other means to another location. The user will place the pet products in the covers 230. The covers 230 will then be placed within the back cover 220. When the covers 230 are placed within the back cover 220, pet products are safely sealed. No outside air or contamination will come and affect the pet products. The covers 230 being within the back cover 220 will effectively provide a protective air tight seal for the pet products. The pet products will be secured within the back cover 220 for up to, but not limited to, multiple week intervals. The user can also put additional pet products in various time intervals into open covers 230, which can then be secured within the back cover 220.

In FIG. 2, the user can effectively pick up, carry, or roll the travelling apparatus 200. The backpack strap 210 will allow the user to carry the travelling apparatus 220 on the user's shoulders for various time intervals. The user will also be able to carry the travelling apparatus 200 by hand in various time intervals. The pulling handle 215 will enable the user to simply roll the travelling apparatus 200 with the pet products in various time intervals as well. In addition the hooking connectors 260 will further enable the user to hook the travelling apparatus onto any stationary kennel when the user decides to place their pet within the stationary kennel during their travel. As such, the back cover 220 provides the versality of storing pet products for long time intervals safety. The outside portion of the back cover 220 also enables the user to hang various travel items according to the user's preference.

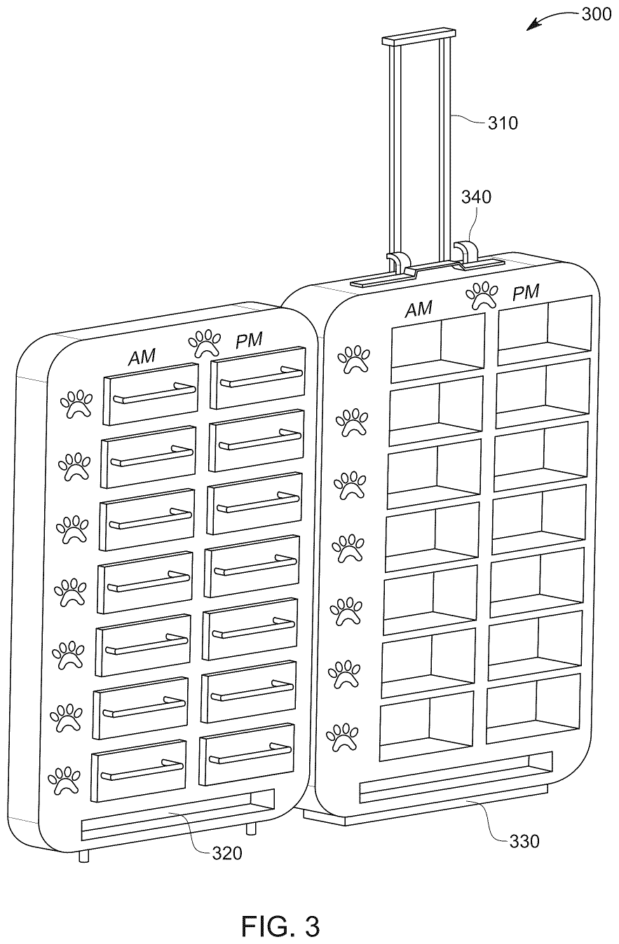

Referring to FIG. 3, another illustration of the travelling apparatus 300 is shown. The travelling apparatus 300 will include the front cover 320 and the back cover 330. The front cover 320 will include drawers that will store the pet products. The pet products will be stored securely with an air tight seal to ensure that the pet products within the drawers do not get contaminated or spoiled. The back cover 330 will also include covers that will store pet products. The pet products within the covers will also have an air tight seal that will protect the pet products from any outside contamination. Both the front cover 320 and the back cover 330 will ensure that the pet products are stored securely for time intervals of up to, but not limited to, multiple week intervals. The handle mechanism 310 and hooking connectors 340 are also shown. The handle mechanism 310 will enable the user to roll the travelling apparatus 300 in any direction. The user will not be unduly burdened with having to physically carry the entire weight of the travelling apparatus 300 by hand. The handle mechanism 310 allows the user to be able to comfortably roll the travelling apparatus 300 from one location to another. The hooking connectors 340 allow the user hang the entire travelling apparatus 300 onto a stationary kennel when the user decides to place his/her pet within the stationary kennel.

In FIG. 3, the front cover 320 and back cover 330 enable the user to store a large supply of pet products within the drawers and covers located within the front cover 320 and back cover 330 respectively. The pet products will be safe within an air tight seal within the front cover 320 and back cover 330. The pet products will be safely stored for up to, but not limited to, multiple week intervals within the front cover 320 and the back cover 330. The handle mechanism 310 will also allow the user to roll the travelling apparatus 300 as the user is travelling. The user will not have to lift the entire weight of the travelling apparatus 300 in order to move the travelling apparatus 300 from one location to another. The hooking connectors 340 on the back cover 330 will allow the user to place the travelling apparatus 300 onto the stationary kennel while the user's pet is placed within the stationary kennel. Overall, pet products are secure within the travelling apparatus 300. The user can also easily move the travelling apparatus 300 to different locations, and also keep their pet nearby as well.

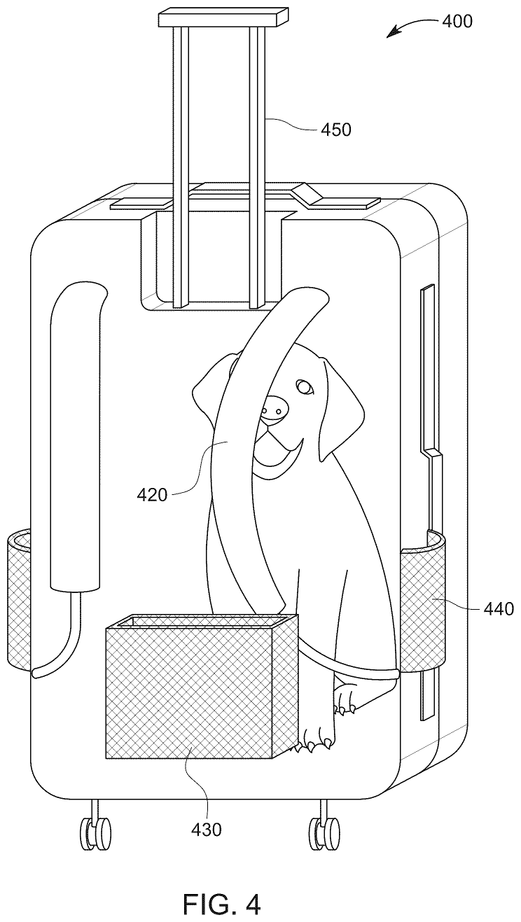

Referring to FIG. 4, a completed version of the travelling apparatus 400 is illustrated. The travelling apparatus can function as a suitcase or as a backpack. The user can decide to roll the travelling apparatus 400, or carry the travelling apparatus 400 by the user's shoulders or hands. The travelling apparatus 400 will include the front cover that includes drawers to store the pet products. The drawers will be sealed air tight when within the front cover. The pet products will remain fresh for time intervals of up to, but not limited to, multiple week intervals. The exterior portion of the travelling apparatus 400 will also include a pocket 430 that can be used to hold pockets of pet products and other pet related items. Further, the exterior region of the travelling apparatus 400 will also include a bottle holder 440. The user can put water bottles within the bottle holder 440.

Referring again to FIG. 4, the travelling apparatus 400 also contains features that allow the user to roll or carry the travelling apparatus 400. The backpack strap 420 on both sides of the back cover will allow the user to carry the travelling apparatus 400 with the pet products that are within the front cover and the back cover. The user can simply place the travelling apparatus 400 on the user's shoulders, or carry the travelling apparatus 400 by hand. The user can also utilize the handle mechanism 450. The handle mechanism 450 will allow the user to roll the travelling apparatus 400 in a similar manner to a travelling suitcase.

With respect to FIG. 4, the user can safely store an abundant supply of pet products within the front cover and the back cover of the travelling apparatus 400. The front cover will store the food safely and securely in an air tight seal within drawers or within plastic storage containers that will keep the pet products fresh and free from any contamination. The back cover of the travelling apparatus 400 will also include covers that will also keep the pet products in an air tight seal, and free from any contamination. As a result, the pet products will remain secure and fresh within the travelling apparatus 400 as the user travels to various locations. The external portion of the travelling apparatus 400 will also allow the user to roll and/or carry the travelling apparatus. The handle mechanism 450 and back pack strap(s) 420 will give the user the option to easily carry or roll the travelling apparatus 400. The user will not be unduly burdened with carrying the weight of the travelling apparatus in a cumbersome manner. The user can also store extra pet products in the pocket(s) 430, and store various bottles in the bottle holder 440.

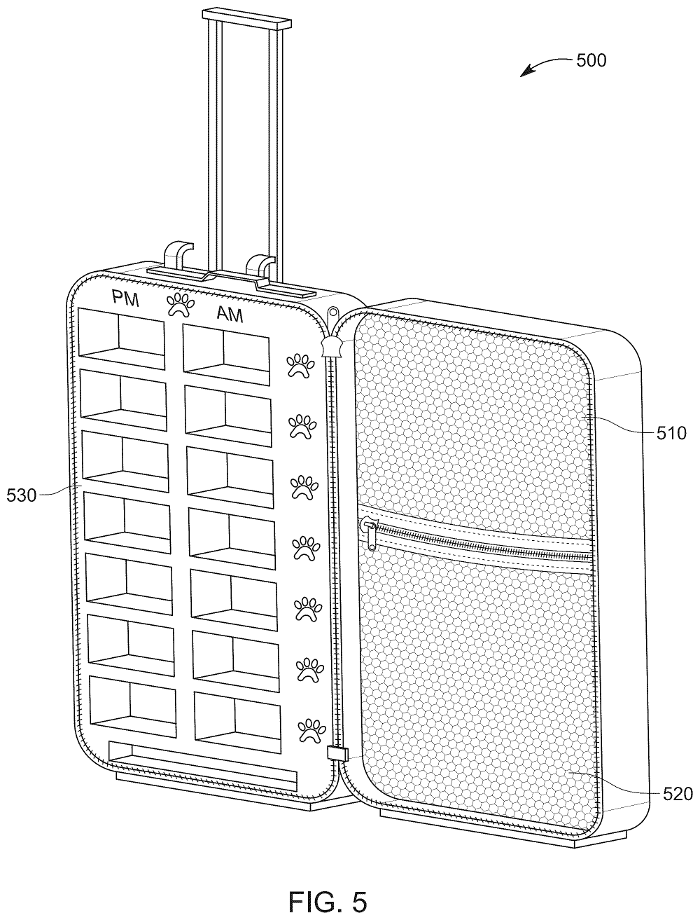

Referring to FIG. 5, an additional bag 500 is illustrated. The additional bag 500 can be comprised or made of various materials. The additional bag 500 can safety keep additional pet materials. The additional bag 500 can be a removable insert that can be equipped with a softer Kevlar type outer shell. The additional bag 500 can also be inserted into a different piece of luggage of the same size. Other options can be that a manufacturer can change the interior compartment to be sized to their desire. Alternatively, one zippered side can be a catch-all for all other items. The entire additional bag 500 can be removable as one piece. The additional bag 500 can be inserted within the travelling apparatus described in the previous figures. In other embodiments, the additional bag 500 can be kept separately from the travelling apparatus as the user is travelling from an initial location to a destination location. The additional bag 500 can include a right component 510 and a left component 520. The other side can include food shelves 530 which can be removable. The removable food shelves 530 can also be used separately and put into any sized case and also be used separately. The additional bag 500, in various embodiments, can also be placed in suitcases of similar sizes as the travelling apparatus.

In the right component 510, various items for the pet can be kept. The items can include, but are not limited to, additional pet food, pet medicine, and pet grooming products. The right component 510 can ensure that the items are kept safely within the top portion of the additional bag 500.

Within the left component 520, further pet items can be kept. The pet items can include, but are not limited to, pet toys and documents relating to the pet's prescribed medications. Additional pet food can also be kept within the open component. Moreover, within either the right component 510 or left component 520, any additional pet items that could not be placed within the travelling apparatus, and can be kept safely within the additional bag 500, may be placed within either the right component 510 or left component 520.

### Summary/Advantages

The travelling apparatus described above will contain many key advantages. The important features of the travelling apparatus will allow the user to safely and securely store pet products for trips that the user is taking to various locations. The front cover contains a plurality of drawers that can each store a good volume of pet products. The drawers can be secured within the front cover, and provide an air tight seal that prevents any outside contamination. In other embodiments, plastic storage containers with covers can store the pet products within the drawers within the front cover. The pet products will be kept fresh for time intervals for up to, but not limited to, multiple week intervals as the user is travelling. The travelling apparatus also includes a back cover that includes plastic storage containers to store pet products. As with the drawers within the front cover, the plastic storage container covers within the back cover will provide an air tight seal for the pet products. No outside contamination will affect the pet products. The pet products will remain fresh within the covers within the back cover for up to, but not limited to, multiple week intervals. A user will be able to keep the pet products fresh within the front cover and back cover of the travelling apparatus.

The travelling apparatus also provides ways for the user to both carry and roll the travelling apparatus with the pet products. The travelling apparatus will include backpack straps to allow the user to carry the travelling apparatus with the pet products on the user's shoulders or in the user's hands. The travelling apparatus will also include a handle or handle mechanism to enable the user to roll the travelling apparatus in a similar manner to user's rolling a suitcase during travel.

The outside of the travelling apparatus also carries features that provide advantages to the user. The outside portion on the back portion of the travelling apparatus include hooking connectors to enable the entire travelling apparatus to be connected to a stationary kennel while the user's pet is stored within the stationary kennel. The features also include one or more pockets that can be placed on the front cover of the travelling apparatus. The pockets will enable the user to store additional pockets of pet products and other items within the one or more pockets. The outside of the travelling apparatus will also include a bottle holder to enable the user to hold water bottles for further use as well.

Overall, the travelling apparatus will enable the user to store a large quantity of pet products in the front and back cover of the travelling apparatus. The pet products will remain fresh for multiple week intervals or more. The travelling apparatus will also enable the user to carry, hold, or roll the travelling apparatus due to the backpack straps and the handle mechanism. In addition, the travelling apparatus allows the user to place his/her travelling apparatus onto a stationary kennel while the user's pet is being stored in the stationary kennel. Further, the travelling apparatus also enables the user to carry bottles of water and additional pet products, and place them in the bottle holder and pocket respectively. The user is able to safely and securely hold pet products, and travel without unduly dealing with the weight of the travelling apparatus. The user is also able to take his/her pet along and carry additional food and liquids if needed given the outside accessories of the travelling apparatus. The internal and external features of the travelling apparatus provide the user safe storage of pet products, and the options of carrying their pet and additional products and liquids for any number of travels that the user desires.

1. A method comprising:
positioning a front cover at an initial position;
configuring a plurality of drawers to be placed within the front cover, wherein the plurality of drawers are configured to carry pet items for one or more periods, of time, wherein the one or more periods of time include multiple week intervals;
placing a back cover behind the front cover and the plurality of drawers; and
moving the combined front cover, plurality of drawers, and back cover using one or more attachments, wherein the one or more attachments are configured to lift and roll the combined front cover, plurality of drawers, and back cover.

2. The method of claim 1, further comprising:
placing an additional bag to carry and store additional pet items.

3. The method of claim 1, wherein the one or more attachments include a pulling handle.

4. The method of claim 1, further comprising:
placing a series of goods within the plurality of drawers.

5. The method of claim 1, further comprising:
storing the food items in the drawers for at least two weeks.

6. The method of claim 1, further comprising:
carrying the combined front cover, drawers, and back cover to one or more locations.

7. The method of claim 1, further comprising:
placing the one or more attachments on the front cover.

8. A method comprising:
configuring a plurality of drawers at an initial position;
placing one or items within the drawers for storage, wherein the one or more items are configured to be stored for intervals of time, wherein the intervals of time include multiple week intervals;
positioning the drawers with the one or more items within a front cover of a traveling apparatus; and
configuring an attachment apparatus on or above the front cover and drawers to move the front cover and drawers in one or more directions.

9. The method of claim 8, wherein the attachment apparatus includes one or more additional bags to store additional pet items.

10. The method of claim 8, further comprising:
placing a back cover in behind the front cover and drawers.

11. The method of claim 8, further comprising:
rolling the drawers and front cover by using the attachment apparatus.

12. The method of claim 8, wherein the one or more items for storage include one or more food items.

13. The method of claim 8, further comprising:
placing one or more plastic storage container covers within a back cover in behind the front cover and drawers.

14. The method of claim 8, further comprising:
providing labeled dates on hours on the drawers within the front cover.

15. A system comprising:
a front cover configured at an initial position;
a plurality of drawers placed within the front cover, wherein the plurality of drawers are configured to carry food items for one or more periods of time, wherein the one or more periods of time include multiple week intervals;
a back cover placed behind the front cover and the plurality of drawers; and
one or more attachments that are placed on the moving the combined front cover, plurality of drawers, and back cover, and configured to lift and roll the combined front cover, plurality of drawers, and back cover.

16. The system of claim 15, wherein the drawers include labeled dates and hours to store the food times for the one or more periods of time.

17. The system of claim 15, wherein additional covers are placed within the back cover to enable the food items to be stored for the one or more periods of time.

18. The system of claim 15, wherein the one or more attachments include a handle to
roll the combined front cover, plurality of drawers, and back cover.

19. The system of claim 15, wherein one or more good items are stored with the one or more food items.

20. The system of claim 15, wherein the one or more attachments include at least one
backpack arm to carry the food items for the one or more periods of time.
